(19) United States
(12) Patent Application Publication
(10) Pub. No.: US 2026/0082012 A1
(43) Pub. Date: Mar. 19, 2026

(54) INFORMATION PROCESSING APPARATUS CONVERTS A SPECIFIED COLOR, METHOD FOR CONTROLLING THE SAME, AND STORAGE MEDIUM

(71) Applicant: CANON KABUSHIKI KAISHA, Tokyo (JP)

(72) Inventor: YUICHIRO SHIBUYA, Kanagawa (JP)

(21) Appl. No.: 19/326,326

(22) Filed: Sep. 11, 2025

(30) Foreign Application Priority Data
Sep. 13, 2024 (JP) 2024-158769

(51) Int. Cl. H04N 1/60

(52) U.S. Cl. CPC H04N 1/6033; H04N 2201/0094

(57) ABSTRACT

An information processing apparatus includes a print unit configured to print print data including a sample of a specific color, a reading unit configured to read a chart printed by the print unit, the chart having arranged therein a patch in the specific color and a plurality of patches that are similar in color to the specific color, a determination unit configured to determine from among the plurality of patches arranged in the read chart that are similar in color to the specific color, a patch in a color that most closely matches the sample of the specific color, and a conversion unit configured to convert the specific color in the print data into the color of the determined patch based on a result of the determination made by the determination unit.

### BACKGROUND

### Field of the Technology

The present disclosure relates to an information processing apparatus, a method for controlling the information processing apparatus, and a storage medium.

### Description of the Related Art

In conventional full-color printing, there are cases where users set their desired color tone for specific colors.

For example, in Japanese Patent Application Laid-Open No. 2022-92814, a desired color tone is set by printing a color chart including a plurality of patches having colors similar to a specific color and visually identifying color numbers corresponding to the respective patches.

However, visual identification of a color tone can lead to inconsistencies between different evaluators, and even the same evaluator may find it difficult to make consistent judgments.

### SUMMARY

The present disclosure is directed to a technique of automatically determining a patch that most closely matches the sample of a specific color.

According to an aspect of the present disclosure, an information processing apparatus includes a print unit configured to print print data including a sample of a specific color; a reading unit configured to read a chart printed by the print unit, the chart having arranged therein a patch in the specific color and a plurality of patches that are similar in color to the specific color; at least one memory storing a program; and at least one processor that, upon execution of the stored program, is configured to function as: a determination unit configured to determine from among the plurality of patches arranged in the read chart that are similar in color to the specific color, a patch in a color that most closely matches the sample of the specific color; and a conversion unit configured to convert the specific color in the print data into the color of the determined patch based on a result of the determination made by the determination unit.

Features of the present disclosure will become apparent from the following description of embodiments with reference to the attached drawings. The following description of embodiments is described by way of example.

### BRIEF DESCRIPTION OF THE DRAWINGS

FIG. 1 is a diagram illustrating a system configuration of a multifunction peripheral (MFP).

FIG. 2 illustrates an external view of the MFP.

FIG. 3 illustrates a view of an operation unit of the MFP.

FIG. 4 is a diagram illustrating a configuration of print job data.

FIG. 5 is a diagram illustrating a module configuration of a program.

FIG. 6 is a diagram illustrating a configuration of a file system.

FIG. 7 illustrates a view of a color chart including a plurality of patches having colors similar to a specific color.

FIG. 8 is a flowchart describing processing for reading the color chart.

FIG. 9 is a flowchart describing print processing.

FIG. 10 illustrates a view of an example of a sample document.

FIG. 11 is a flowchart describing processing for reading the sample document.

FIG. 12 is a flowchart describing coordinated processing for reading the color chart and the sample document.

FIG. 13 illustrates a view of a screen displayed on a touch panel section of the operation unit.

### DESCRIPTION OF THE EMBODIMENTS

Some exemplary embodiments to implement the present disclosure will now be described with reference to the drawings. However, constituent elements described in the following exemplary embodiments are merely examples and are not intended to limit the scope of the present disclosure.

Some exemplary embodiments to implement the present disclosure will be described with reference to the drawings. A first exemplary embodiment will now be described.

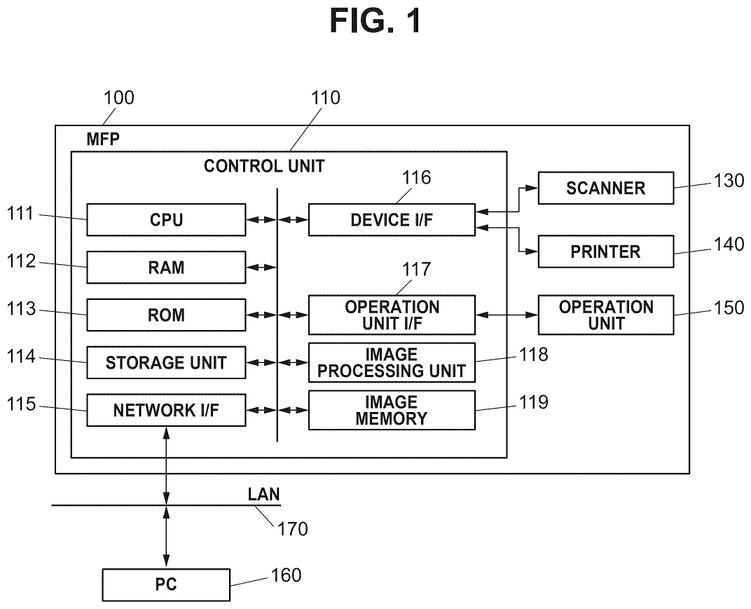

FIG. 1 is a diagram illustrating a system configuration of a multifunction peripheral (MFP) 100 used as an information processing apparatus according to the first exemplary embodiment.

A control unit 110 is connected to a scanner (a chart reading unit) 130 as an image input device and a printer 140 as an image output device and controls the input and the output of image information. Further, the control unit 110 is connected to a local area network (LAN) and performs reception of print job data 400 or other operations via the LAN.

The control unit 110 includes a determination unit for determining a patch that most closely matches a sample of a specific color (i.e., a sample color).

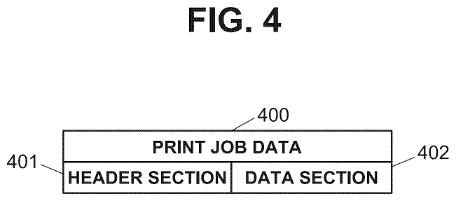

The print job data 400 includes a header section 401 in which print information is stored and a data section 402 in which page description language (PDL) data and image data is stored (FIG. 4).

A central processing unit (CPU) 111 controls the operation of the MFP 100 and operates based on a program 500 stored in a random-access memory (RAM) 112.

Print data is identical to print job data.

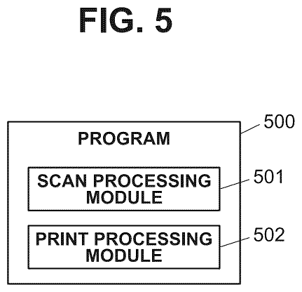

A scan processing module 501, a print processing module 502, and the like are stored in the program 500 (FIG. 5).

A read-only memory (ROM) 113 is a boot ROM, and a boot program of a system is stored therein.

System software, image data, a program to control the operation of the MFP 100, and the like are stored in a storage unit 114.

The program 500 stored in the storage unit 114 is loaded into the RAM 112, and the CPU 111 controls the operation of the MFP 100 based on the program 500.

To access the storage unit 114, a file system 600 is used that is capable of handling image data and PDL data in the storage unit 114 as individual files.

With the file system 600, it is possible to receive instructions from an application, and, according to contents of the instructions, designate file names with file paths to open files, write data to the files, and read data from the files.

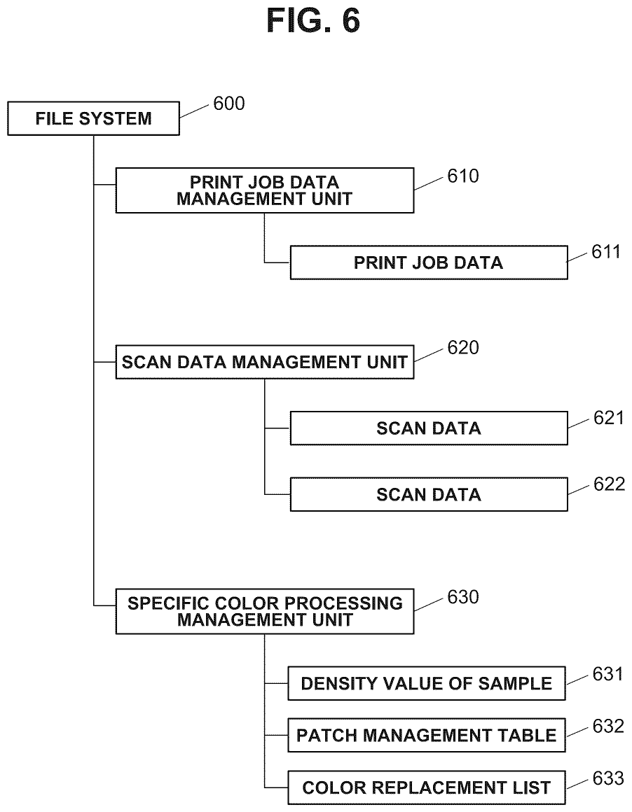

In the file system 600, a print job data management unit 610 for storing PDL data, a scan data management unit 620 for storing scan data, and a specific color processing management unit 630 for storing files regarding specific color processing exist as different file paths (FIG. 6).

A network interface (I/F) 115 is connected to the LAN, and performs communication with an external device, such as a personal computer (PC) 160, via a network, and manages the input and the output of various kinds of information.

A device I/F 116 connects the scanner 130 and the printer 140 as the image input and output devices, respectively, and the control unit 110 to perform synchronous or asynchronous conversion processing on image data.

An operation unit I/F 117 connects the operation unit 150 and the control unit 110, and outputs image data to be displayed on the operation unit 150 to the operation unit 150.

The operation unit I/F 117 transmits information input by a user from the operation unit 150 to the CPU 111.

An image processing unit 118 performs image processing on print job data received via the LAN or image data input from or output to the device I/F 116.

An image memory 119 is used for temporarily loading image data to be processed by the image processing unit 118.

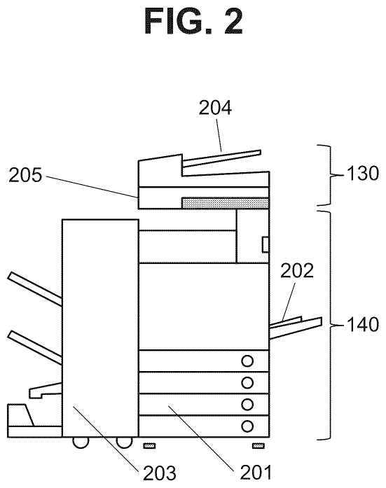

FIG. 2 illustrates an external view of the MFP 100. In the MFP 100, the scanner 130 is disposed on the printer 140.

The scanner 130 includes an automatic document feeder (ADF) 204 and a reader 205.

The ADF 204 sequentially separates a stack of documents placed on the placement surface of the document tray starting from the first page in the order of pages and conveys each document to a platen glass to scan by using the reader 205.

The reader 205 reads an image of each document conveyed to the platen glass by the ADF 204 or an image of each document placed on the platen glass and converts the image into image data using a charge-coupled device (CCD).

The printer 140 is provided with two types of paper holding units: a plurality of cassettes 201 each capable of holding several hundred sheets in a single tray, and a manual feed tray 202 that facilitates manual replacement of sheets. Sizes and types of sheets placed in the cassettes 201 are set by the user via a not-illustrated operation screen and are stored in association with each cassette in the storage unit 114. The sizes and the types of sheets placed in the cassettes 201 or the size and the type of sheets placed on the manual feed tray 202 can be automatically detected.

A paper discharge apparatus 203 is capable of performing print finishing processing, such as stapling or punching holes in sheets subjected to image formation output from the printer 140.

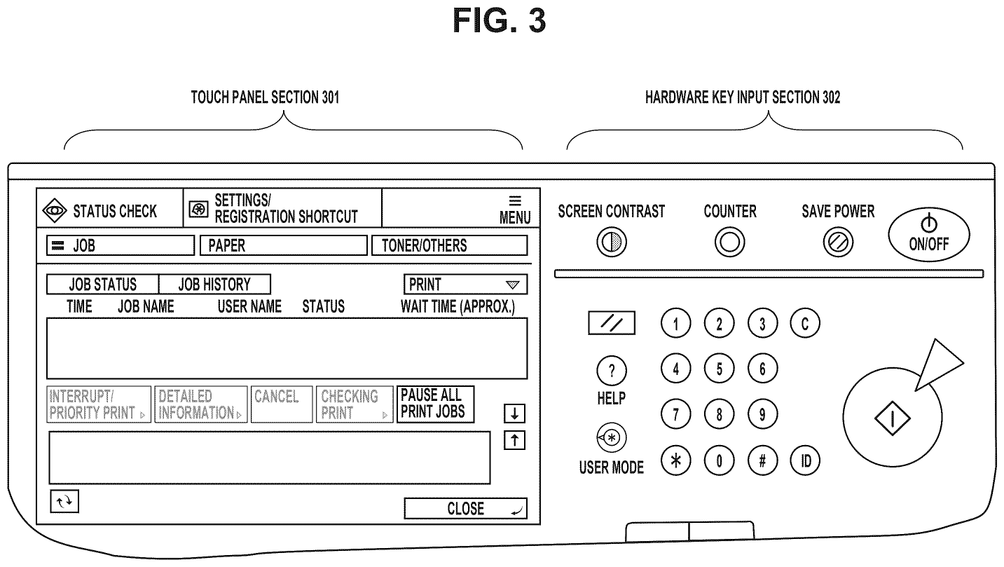

FIG. 3 illustrates a view of the operation unit 150 of the MFP 100. The operation unit 150 includes a hardware key input section (a key input section) 302 and a touch panel section 301. The operation unit 150 receives instructions from the user via these sections. Further, the operation unit 150 performs various kinds of display operations on the touch panel section 301 included in the operation unit 150.

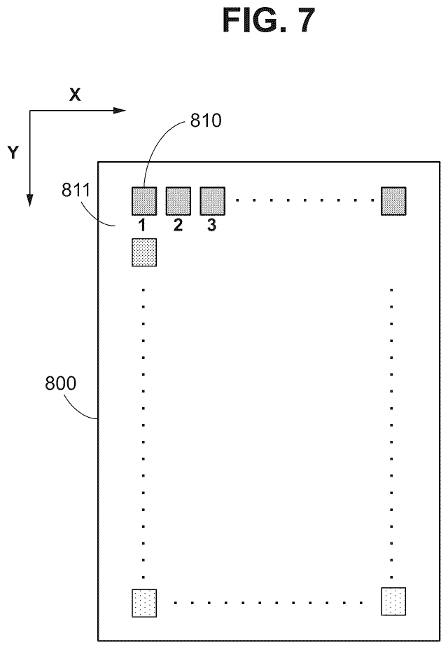

FIG. 7 illustrates a view of a color chart 800 including a plurality of patches having colors similar to a specific color.

In response to an instruction received from the PC 160 via a LAN 170, the control unit 110 causes the color chart 800 to be printed.

In the color chart 800, a large number of patch images 810 having the specific color and its similar colors are arranged together with corresponding patch numbers 811. Each patch number 811, color values corresponding to each patch image 810, and position information on a sheet are associated with one another in a patch management table 632 as shown in Table A.

The density of each patch image 810 on a sheet can be measured using the color chart 800.

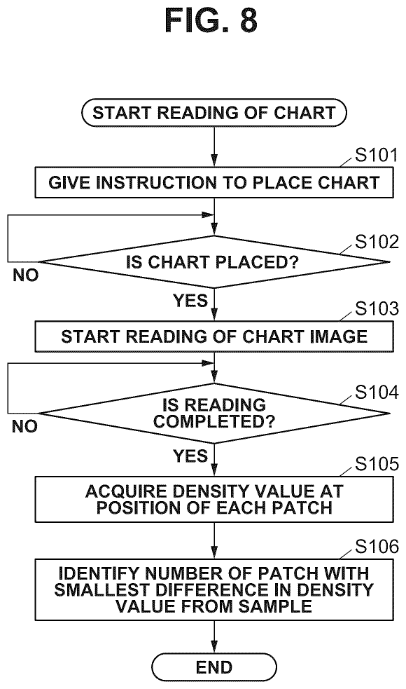

FIG. 8 is a flowchart describing processing for reading the color chart 800 in the MFP 100 according to the present exemplary embodiment. The scan processing module 501 of the MFP 100 according to the present exemplary embodiment is stored in the program 500, loaded into the RAM 112, and executed by the CPU 111.

In step S101, the control unit 110 performs display on the operation unit 150 to prompt the user to place the color chart 800 on the scanner 130, and the processing proceeds to step S102.

In step S102, if the scanner 130 detects the placement of the color chart 800 (YES in step S102), the processing proceeds to step S103. If the scanner 130 does not detect the placement of the color chart 800 (NO in step S102), the processing of step S102 is repeated.

In step S103, the control unit 110 instructs the scanner 130 to read the color chart 800, and the processing proceeds to step S104.

In step S104, if the scanner 130 completes reading of the color chart 800 and stores data as scan data 621 in a scan data management unit 620 (YES in step S104), the processing proceeds to step S105. If the scanner 130 does not complete reading of the color chart 800 and store data as scan data 621 in a scan data management unit 620 (NO in step S104), the processing of step S104 is repeated.

In step S105, the control unit 110 acquires, from the scan data 621 stored in the scan data management unit 620, density values of patches at positions X and Y, which are stored in the patch management table 632, and stores the density values at each patch position in association with corresponding patch numbers in the RAM 112.

In step S106, the control unit 110 compares the density value at each patch position stored in the RAM 112 and a density value 631 of the sample (the sample color) preliminarily stored in the specific color processing management unit 630 to identify a number at the position of a patch with the density value that most closely matches the density value 631 of the sample. The control unit 110 then determines the identified number to be a patch number with the density value that most closely matches the density value 631 of the sample. The control unit 110 uses the patch management table 632 to acquire a corresponding density value based on the determined patch number, stores a corresponding color as a target color in a color replacement list 633 in the specific color processing management unit 630, and ends the processing.

Here, the number (the patch number) at a position of the patch with the density value that most closely matches the density value of the sample serves as a determination result, but the determination result is not limited to the patch number. For example, the determination result may be information indicating the position of a patch in a chart (for example, coordinate information in the chart).

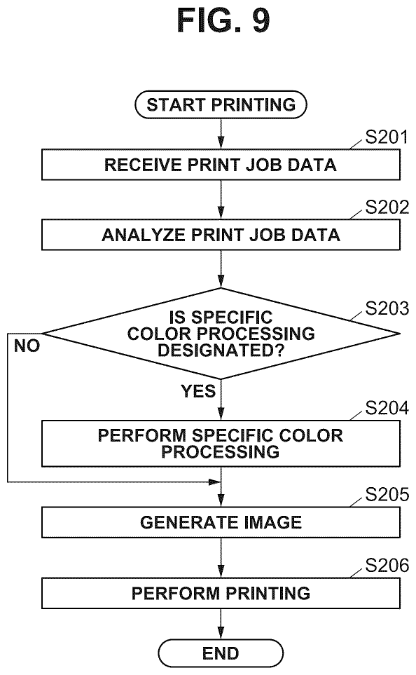

FIG. 9 is a flowchart describing print processing in the MFP 100 according to the present exemplary embodiment. The print processing module 502 of the MFP 100 according to the present exemplary embodiment is stored in the program 500, loaded into the RAM 112, and executed by the CPU 111.

In step S201, upon receiving print job data transmitted from the PC 160 by the network I/F 115 via the LAN 170, the control unit 110 stores the print job data in the print job data management unit 610, and the processing proceeds to step S202.

In step S202, the control unit 110 analyzes the header section 401 and the data section 402 of the print job data stored in the print job data management unit 610 and stores the result of the analysis in the RAM 112. Analyzing the header section 401 makes it possible to acquire setting information regarding a print job, such as information regarding whether specific color processing is designated. In the analysis of the data section 402, image information and a color value from PDL data can be acquired to generate a control command as an input for image generation.

In step S203, if the specific color processing is designated in the print job data, (YES in step S203), the processing proceeds to step S204. If the specific color processing is not designated (NO in step S203), the processing proceeds to step S205.

In step S204, the control unit 110 reads the color replacement list 633 from the specific color processing management unit 630. If the color value acquired by the data analysis described above matches a color value of the specific color registered in the color replacement list 633, the control unit 110 converts the color value acquired by the data analysis to a color value of the target color associated with the specific color (Table B).

In step S205, the control unit 110 generates image data in a raster format in a red, green, and blue (RGB) color space (hereinafter referred to as “RGB raster image data”) based on the control command generated by the data analysis described above. In this case, if pixels having the specific color are included in pixels constituting the input image, RGB values of the specific color are substituted with RGB values of the target color.

After the RGB raster image data is generated, the control unit 110 converts the respective pixel values of pixels in the RGB raster image data from the RGB values into cyan, magenta, yellow, and black (CMYK) values. With this color conversion processing, image data is generated in a raster format, which is represented in the CMYK color space (hereinafter referred to as “CMYK raster image data”).

After the CMYK raster image data is generated, the control unit 110 performs half-tone processing on the generated CMYK raster image data to generate image data processable by the printer 140 (half-tone image data).

In step S206, the control unit 110 transmits the generated half-tone image data to the printer 140. After the half-tone image data is transmitted, the printer 140 forms an image on a sheet based on the half-tone image data, conveys the sheet on which the image is formed to the paper discharge apparatus 203, and ends the processing.

In the present exemplary embodiment, by reading the color chart 800 including a plurality of patches having colors similar to a specific color and comparing the plurality of patches with a sample of the specific color, a patch that most closely matches the sample of the specific color can be automatically determined.

A second exemplary embodiment will now be described. In the first exemplary embodiment, the configuration has been described where the density value 631 of a sample of the specific color is preliminarily stored. However, in the present exemplary embodiment, a result of reading a sample document 1000 (sample reading) may be stored as a density value of the sample. The procedures of reading the color chart 800 and printing are almost identical to those in the first exemplary embodiment, and thus, only the different parts will be described in the following.

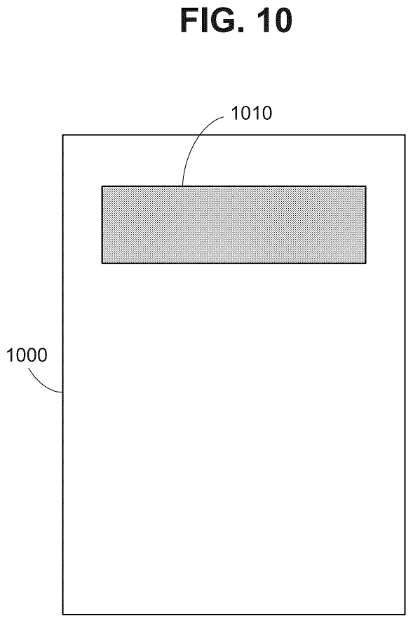

FIG. 10 illustrates a view of an example of the sample document 1000.

A sample image 1010 as the sample of the specific color is disposed on the sample document 1000.

A density value of the sample can be acquired by measuring a color of the sample image 1010.

The sample document 1000 may be or may not be a print product printed by the MFP 100 itself.

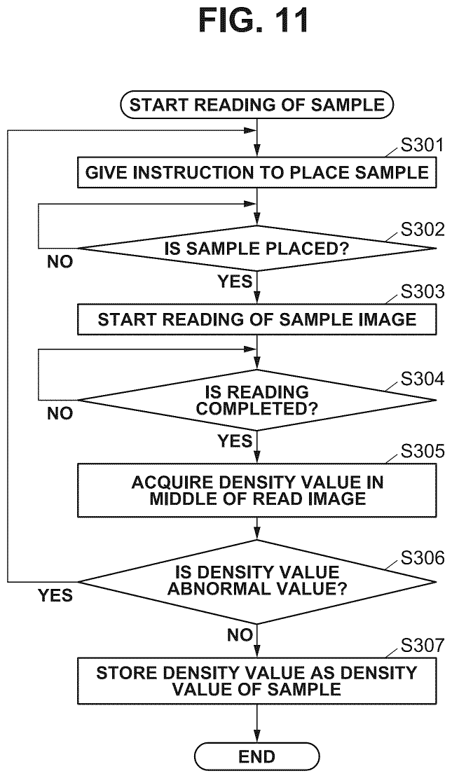

FIG. 11 is a flowchart describing processing for reading the sample document 1000 in the MFP 100 according to the present exemplary embodiment. The scan processing module 501 of the MFP 100 according to the present exemplary embodiment is stored in the program 500, loaded into the RAM 112, and executed by the CPU 111.

In step S301, the control unit 110 performs display on the operation unit 150 to prompt the user to place an image to be read in the sample document 1000 on the middle of the platen glass of the reader 205, and the processing proceeds to step S302.

In step S302, if the scanner 130 detects the placement of the sample document 1000 (YES in step S302), the processing proceeds to step S303. If the scanner 130 does not detect the placement of the sample document 1000 (NO in step S302), the processing of step S302 is repeated.

In step S303, the control unit 110 instructs the scanner 130 to read the sample document 1000, and the processing proceeds to step S304.

In step S304, if the scanner 130 completes reading of the sample document 1000 and stores data as scan data 622 in the scan data management unit 620 (YES in step S304), the processing proceeds to step S305. If the scanner 130 does not complete reading of the sample document 1000 and does not store data as scan data 622 in the scan data management unit 620 (NO in step S304), the processing of step S304 is repeated.

In step S305, the control unit 110 acquires, from the scan data 622 stored in the scan data management unit 620, a density value in the middle of the position of the sample image 1010 and stores the density value in the RAM 112, and the processing proceeds to step S306.

In step S306, the control unit 110 determines whether the density value stored in the RAM 112 is within a predetermined range (i.e., whether the density value is an abnormal value). If the control unit 110 determines that the density value is not within the predetermined range (i.e., is not an abnormal value) (NO in step S306), the processing proceeds to step S307. If the control unit 110 determines that the density value is within the predetermined range and is an abnormal value (YES in step S306), the control unit 110 performs the processing from step S301 again.

With this processing, if the read density value is determined to be an abnormal value, the user is prompted to re-place (relocate) the sample document 1000 on the platen glass of the reader 205. This leads to accurate reading of the sample document 1000 at an appropriate density (i.e., with appropriate placement of the sample document 1000).

In step S307, the control unit 110 stores the density value stored in the RAM 112 as the density value 631 of the sample in the specific color processing management unit 630 and ends the processing.

In the present exemplary embodiment, by reading the color chart 800 including a plurality of patches having colors similar to a specific color and comparing the plurality of patches with a sample of the specific color, a patch that most closely matches the sample of the specific color can be automatically determined.

A third exemplary embodiment will now be described. The user is prompted to place the image to be read in the sample document 1000 on the middle of the platen glass of the reader 205 in the second exemplary embodiment. However, a procedure can be employed of designating a reading position with the touch panel section 301 of the operation unit 150. The procedures of reading the color chart 800 and printing are almost identical to those in the first exemplary embodiment, and thus, only the different parts will be described in the following.

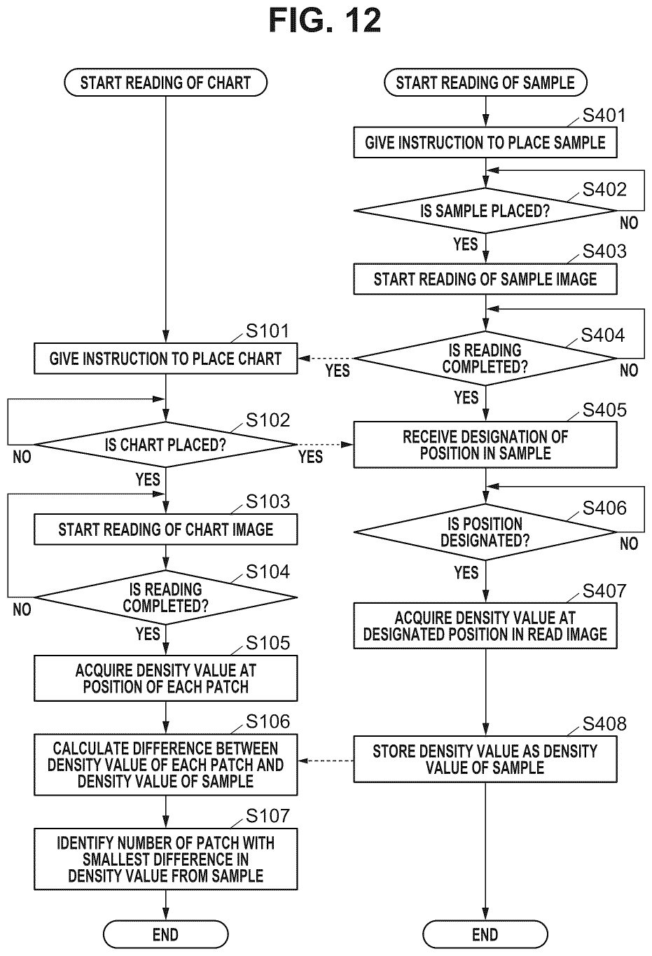

FIG. 12 is a flowchart describing coordinated processing for reading the color chart 800 and the sample document 1000 in the MFP 100 according to the present exemplary embodiment. The scan processing module 501 of the MFP 100 according to the present exemplary embodiment is stored in the program 500, loaded into the RAM 112, and executed by the CPU 111.

In step S401, the control unit 110 performs display on the operation unit 150 to prompt the user to place the sample document 1000 in the ADF 204 or on the platen glass of the reader 205, and the processing proceeds to step S402.

In step S402, if the scanner 130 detects the placement of the sample document 1000 (YES in step S402), the processing proceeds to step S403. If the scanner 130 does not detect the placement of the sample document 1000 (NO in step S402), the processing of step S402 is repeated.

In step S403, the control unit 110 instructs the scanner 130 to read the sample document 1000, and the processing proceeds to step S404.

In step S404, if the scanner 130 completes reading of the sample document 1000 and stores data as the scan data 622 in the scan data management unit 620 (YES in step S404), the processing proceeds to step S405. Further, the instruction of placement of the color chart 800 in step S101 of the color chart reading procedure starts at the same time. If the scanner 130 does not complete reading of the sample document 1000 and does not store data as the scan data 622 in the scan data management unit 620 (NO in step S404), the processing of step S404 is repeated.

In step S405, after the completion of placement of the color chart 800 is detected in step S102 of the color chart reading procedure, a screen is displayed on the touch panel section 301 of the operation unit 150 for the user to designate a position at which to read a density from the sample document 1000, and the processing proceeds to step S406.

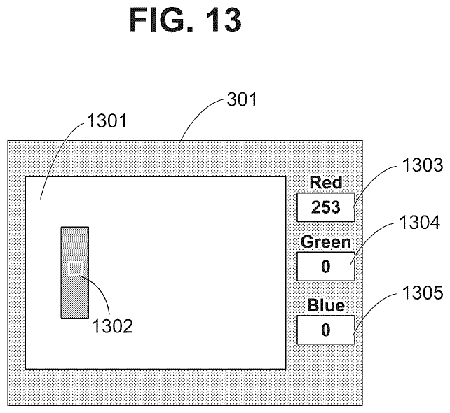

FIG. 13 illustrates a view of the screen displayed on the touch panel section 301 of the operation unit 150.

An area 1301 displays an image of the scan data 622 stored in the scan data management unit 620.

An operation cursor 1302 indicates a position on an image at which the density of a color in the scan data 622 is measured. The user can designate the position of the operation cursor 1302 on the touch panel section 301.

An area 1303 shows a density value of red (R), an area 1304 shows a density value of green (G), and an area 1305 shows a density value of blue (B), all of which reflect the respective R, G, and B density values at a position on the image in the scan data 622 indicated by the operation cursor 1302.

In step S406, if the user has designated a position at which to read a density from the sample document 1000 (YES in step S406), the processing proceeds to step S407. If the user has not designated a position at which to read a density from the sample document 1000 (NO in step S406), the processing of step S406 is repeated. In step S407, the control unit 110 acquires, from the scan data 622 stored in the scan data management unit 620, a density value at the position of the image designated by the user in step S405 and stores the density value in the RAM 112, and the processing proceeds to step S408.

In step S408, the control unit 110 stores the density value stored in the RAM 112 as the density value 631 of the sample in the specific color processing management unit 630. Further, the control unit 110 starts step S106 of the color chart reading procedure to calculate the difference between the density value of each patch of the color chart 800 and the density value 631 of the sample and ends the processing of the procedure of reading the sample document 1000 for the specific color.

In the present exemplary embodiment, allowing a reading position of the sample document 1000 for the specific color to be designated makes it possible to prevent re-reading of the sample document 1000 caused by erroneous placement of the sample document 1000. Further, by coordinating the reading procedure of the color chart 800 with the reading procedure of the sample document 1000 for the specific color, the process can be performed in a shorter time than when each procedure operates independently.

### Other Exemplary Embodiments

The present disclosure may be implemented as a program that causes a computer to carry out one or more functions of the above-described exemplary embodiments, or it may be a storage medium in which the program is stored.

The present disclosure is not limited to the above-described exemplary embodiments and can be modified in various manners (including an organic combination of the above-described exemplary embodiments) based on the gist of the present disclosure. These modifications are not excluded from the scope of the present disclosure. Thus, all configurations obtained by combining the above-mentioned exemplary embodiments and modifications of the exemplary embodiments are included in the present disclosure.

TABLE 1
Table A

| | Color | Color | Color | | |
|---|---|---|---|---|---|
| Patch | value of | value of | value of | Position | Position |
| number | R | G | B | X | Y |
| 0 | 255 | 0 | 0 | 200 | 200 |
| 1 | 254 | 0 | 1 | 600 | 200 |

TABLE 2
Table B

| Specific color | | | Target color | | |
|---|---|---|---|---|---|
| R | G | B | R | G | B |
| 255 | 0 | 0 | 250 | 0 | 5 |

According to the present disclosure, by reading the color chart including a plurality of patches having colors similar to a specific color and comparing the patches with a sample of the specific color, a patch that most closely matches the sample of the specific color can automatically be determined.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims priority to and the benefit of Japanese Patent Application No. 2024-158769, filed Sep. 13, 2024, the entirety of which is incorporated herein by reference.

What is claimed is:

1. An information processing apparatus comprising:
a print unit configured to print print data including a sample of a specific color;
a reading unit configured to read a chart printed by the print unit, the chart having arranged therein a patch in the specific color and a plurality of patches that are similar in color to the specific color;
at least one memory storing a program; and
at least one processor that, upon execution of the stored program, is configured to function as:
a determination unit configured to determine from among the plurality of patches arranged in the read chart that are similar in color to the specific color, a patch in a color that most closely matches the sample of the specific color; and
a conversion unit configured to convert the specific color in the print data into the color of the determined patch based on a result of the determination made by the determination unit.

2. The information processing apparatus according to claim 1, wherein the determination unit is configured to identify a number allocated to the patch in the color that most closely matches the sample of the specific color.

3. The information processing apparatus according to claim 2, wherein the conversion unit is configured to convert the specific color in the print data into the color of the determined patch based on the number that is allocated to the determined patch and that is identified by the determination unit.

4. The information processing apparatus according to claim 1, wherein the sample of the specific color is a print product printed by the print unit.

5. A method of controlling an information processing apparatus, the method comprising:
reading a chart including a print product that includes a sample of a specific color, a patch in the specific color, and a plurality of patches that are similar in color to the specific color;
determining from among the plurality of patches arranged in the read chart that are similar in color to the specific color, a patch in a color that most closely matches the sample of the specific color; and
converting the specific color into the color of the determined patch based on a result of the determination.

6. A non-transitory computer-readable storage medium that stores a program causing an information processing apparatus to execute a control method, the method comprising:
reading a chart including a print product that includes a sample of a specific color, a patch in the specific color, and a plurality of patches that are similar in color to the specific color;
determining from among the plurality of patches arranged in the read chart that are similar in color to the specific color, a patch in a color that most closely matches the sample of the specific color; and
converting the specific color into the color of the determined patch based on a result of the determination.
